(19) United States
(12) Patent Application Publication
(10) Pub. No.: US 2025/0334730 A1
(43) Pub. Date: Oct. 30, 2025

(54) METHOD AND APPARATUS FOR IMPROVING DISPLAY UNIFORMITY OF VOLUME HOLOGRAPHIC OPTICAL WAVEGUIDE

(71) Applicant: Nika Optics (Tianjin) Co., Ltd., Tianjin (CN)

(72) Inventors: Mu YANG, Tianjin (CN); Haibin LIN, Tianjin (CN); Youcheng DU, Tianjin (CN)

(21) Appl. No.: 19/029,977

(22) Filed: Jan. 17, 2025

(30) Foreign Application Priority Data
Apr. 24, 2024 (CN) 202410498079.9

(51) Int. Cl. G02B 5/32; G03H 1/00

(52) U.S. Cl. CPC G02B 5/32; G03H 1/0005; G03H 2001/0088

(57) ABSTRACT

The present disclosure provides a method and apparatus for improving display uniformity of a volume holographic optical waveguide. Specifically, the volume holographic optical waveguide includes a switchable grating structure, a partial region on the switchable grating structure is directionally selected as a coupling region thereof, such that a light source can only be coupled out of the coupling region at the maximum diffraction efficiency thereof. The coupling region on the switchable grating structure is continuously switched, and the time in which the coupling region covers all the regions is made not more than the visual retention time of human eyes.

### CROSS REFERENCE TO RELATED DISCLOSURES

The present disclosure claims priority from Chinese Disclosure No. CN 202410498079.9 filed on Apr. 24, 2024, all of which are hereby incorporated herein by reference.

### TECHNICAL FIELD

The present disclosure relates to the field of holographic projection display, in particular to a method and apparatus for improving display uniformity of a volume holographic optical waveguide.

### BACKGROUND

The augmented reality (AR) technology is a kind of technology cleverly integrating virtual information with the real world, and through such a technology, computer-generated virtual information such as texts, images, three-dimensional models, and music and videos may be simulated and then applied to the real world, so as to achieve “augmentation” of the real world. At present, during practical disclosures of the augmented reality technology, the apparatus that implements the AR display technology usually consists of display devices and optical devices, where the mainstream technology for optical devices is optical waveguide technology, specifically including geometric optical waveguide and diffraction optical waveguide. The diffraction optical waveguide is realized through “transporting” the virtual image in front of human eyes, and plays a role in reproducing an exit pupil. In particular, the diffraction optical waveguide consists of a planar optical waveguide and a plurality of diffracted gratings, which mainly includes the surface relief grating waveguide manufactured using a photoetching technology and the volume holographic grating waveguide manufactured based on a holographic interference technology.

An AR display apparatus based on the volume holographic grating waveguide technology is usually provided with such grating structures including a coupling-in grating, a fold grating and a coupling-out grating. The beam projected by a projection optical machine is subjected to beam expansion and collimation and is coupled into the waveguide from the coupling-in grating region, and then diffracted by the coupling grating to produce a beam performing total reflection in the waveguide, the total reflection beam obtained can be propagated along the waveguide direction in the waveguide until reaching to the fold grating, then deflected by the fold grating by a certain angle to be propagated along the waveguide in the other direction in the waveguide, and finally reaches to the coupling-out grating, then the total reflection beam is diffracted by the coupling-out grating and is coupled out of the waveguide and accepted by human eyes for imaging. However, the existing AR display apparatuses generally have the problem of poor uniformity. As an important property in AR display technology, uniformity usually includes both color uniformity and brightness uniformity, and plays a decisive role in accurate reproduction of image colors in an eye box or in the field angle in AR display. Particularly, poor brightness uniformity may greatly affect the clarity, three-dimensionality, and accuracy of an image, thereby influencing the visual effect. Specifically, due to the existence of a diffraction effect and the image projection screen having a certain range of field angle, such a range of field angle may cause different sizes of pupil imprinting of the pupil in the waveguide, which leads to banding, thereby becoming a source of non-uniform optical field. Furthermore, due to low efficiency of grating diffraction, when the propagating beam within the waveguide encounters the fold grating or the coupling-out grating, the beam is propagated in these gratings and diffracted many times, which expands the pupil and thus expands the eye box range. However, with the loss of beam energy each time the beam is propagated and diffracted, the energy of light during each diffraction is different, thereby resulting in non-uniform distribution of optical intensity in the entire coupling-out region, and relatively low brightness of the actually coupled-out light.

In order to balance the optical field distribution in the AR display apparatus based on the volume holographic grating waveguide technology and reduce the non-uniformity of the emitted light, an improved method often used in the prior art is provided. Such method is provided with a coupling-out grating with a variable diffraction efficiency, a refractive index modification layer with semi-transparent and semi-reflective properties, and multiplexed coupling grating or overlapped grating. For the coupling-out grating with variable diffraction efficiency, one end close to the propagation direction of the beam has a lower diffraction efficiency, while the other end has a higher diffraction efficiency to balance the energy of the coupling-out beam of all the regions. For the refractive index modification layer with semi-transparent and semi-reflective properties, the uniformity of the optical field of an exit pupil region is improved with deviation of a pupil. For the multiplexed coupling grating or overlapped grating, the pupil is deviated and the grating diffraction efficiency is modulated through changing the combined property of the grating. However, holographic grating with variable diffraction efficiency needs to modulate refractive index modulation degree of a holographic film material. The refractive index modulation degree of the holographic film material is changed mainly through changing a composition ratio of the holographic material in different regions or through changing the grating exposure doses of different regions, no matter which method is adopted, the diffraction efficiency cannot be changed gradually in the grating propagation direction and a certain non-uniformity still exists, and these methods usually require special processing technology and complex processing processes. In addition, by adding the refractive index modification layer with semi-transparent and semi-reflective properties in the waveguide, or by multiplexed and overlapped gratings, the difficulty in processing of the overall waveguide will be greatly increased, and the influence of additional stray light will be increased.

### SUMMARY

The present disclosure provides a method and apparatus for improving display uniformity of a volume holographic optical waveguide, which can improve the brightness and uniformity of the volume holographic grating optical waveguide.

One object of the present disclosure is to provide a method for improving display uniformity of a volume holographic optical waveguide, comprising providing the volume holographic optical waveguide with a switchable grating structure, wherein a partial region of the switchable grating structure is directionally selected as a coupling region thereof, in a way that a light beam from a light source is only capable of being coupled out of the coupling region at the maximum diffraction efficiency thereof; and continuously switching the coupling region on the switchable grating structure, wherein a process in which the continuously switched coupling region covers all the regions of the switchable grating structure is taken as one scanning, and the time for one scanning is not more than a visual retention time of human eyes.

In the present disclosure, a switchable grating structure is used in the volume holographic optical waveguide, and as to the switchable grating structure, a partial region may be directionally selected as a coupling region, such that the light beams form the light source can only be emitted from the coupling region. That is, the beams are concentrated in a partial region on the switchable grating structure and are coupled out each time the light is emitted, thereby reducing the imbalance of the energy of the beam on the coupling-out region during a single light emission, and improving the brightness and uniformity of the light emitted at a single time. The coupling region can be freely selected in the switchable grating structure, i.e., all the regions on the switchable grating structure can have the same light emitting effect, which also means the same brightness and angle uniformity.

In addition, by continuously switching the coupling region on the switchable grating structure, the light source can move freely in different regions on the switchable grating structure through an output field of view of the switchable grating structure, and since the brightness and angle uniformity of the beam penetrating through each coupling region on the switchable grating structure are all consistent, the brightness and uniformity of the light emitted at a single time are kept consistent in the full output field of view, thereby constructing more balanced optical field distribution and improving the overall display effect.

Further, during light emitting at a single time, the light source is coupled out at the maximum diffraction efficiency thereof when passing through the coupling region, that is, the grating structure of the coupling region is modulated with a maximum diffraction efficiency, such that the light beam can couple out most of the light energy during each diffraction when passing through the coupling region, thereby further improving the brightness and uniformity of the light emitted at a single time. The maximum diffraction efficiency should be the maximum coupling efficiency for the best brightness visual effect capable of being achieved by the grating structures in the prior art or future technological development, preferably, the maximum diffraction efficiency in the prior art should be an efficiency not lower than 60%, preferably higher than 80%, and not excluded higher than 95%. The switchable grating structure as a whole is preferably modulated to be at its maximum diffraction efficiency, thereby maximizing the utilization rate of the beam over all the regions and improving the overall brightness of the beam. Since the switchable grating structure as a whole has the same diffraction efficiency, preferably the maximum diffraction efficiency, all the gratings on the switchable grating can have the same optical properties, then the same manufacturing process may be adopted to ensure consistency of all the properties of the grating structure, thereby further greatly reducing complexity and difficulty in making gratings, improving the production efficiency, and further improving usage property of the grating structure.

In the present disclosure, taking a process in which the continuously switched coupling regions cover all the regions of the switchable grating structure as one scanning, through one scanning, the light beam bearing images may be coupled out once from all the regions of the switchable grating structure, and the time for one scanning is made not more than the visual retention time of human eyes, that is, the images observed by human eyes through the volume holographic optical waveguide display apparatus are just all the images with improved brightness and uniformity, thereby improving the quality of images observed by human eyes while ensuring visual experience. Preferably, the light beam with images can repeatedly scan on the same switchable grating structure to better improve the visual communication effect.

Preferably, according to the present disclosure, the switchable grating structure is a grating array formed by a plurality of sub-gratings arranged directionally, and the coupling region of the grating array is directionally selected by controlling the opening or closing of part of the sub-gratings in the grating array; and the scanning manner is sequential scanning or random scanning, and at least one of the sub-gratings is opened each time during sequential scanning or random scanning.

With the switchable grating structure in a grating array formed by a plurality of sub-gratings arranged directionally, the selection of the coupling region can be controlled by the sub-grating dimension, i.e., by controlling part of the sub-gratings in the grating array to be open and controlling the other part of the sub-gratings to be closed. Therefore, the coupling region on the switchable grating structure can be directionally selected conveniently and rapidly. Preferably, at least one sub-grating is opened during each scanning. The coupling region is selected and switched through controlling sub-gratings, thereby not only improving the precision and convenience of selection and control of the coupling region, but also broadening the scanning methods on the switchable grating structure, so as to adapt to different disclosure scenarios and bringing different visual effect experiences. In particular, in order to make the coupling regions continuously switched to perform scanning in the full field of view, regional sequential scanning can be formed by sequentially selecting and opening sub-gratings, alternatively regional random scanning can also be formed by randomly selecting and opening sub-gratings.

Another object of the present disclosure is to provide a volume holographic optical waveguide display apparatus, which is adapted to conduct the method mentioned above to improve its display uniformity.

The volume holographic optical waveguide display apparatus in the present disclosure includes an optical mechanical system, a waveguide system and a control system. The optical mechanical system is configured to emit a collimated light beam. The waveguide system includes a waveguide substrate and a grating structure arranged in the waveguide substrate. The grating structure at least includes a coupling-in grating and a coupling-out grating. The collimated light beam is coupled into the waveguide substrate through the coupling-in grating, propagated towards the coupling-out grating, then is subjected to pupil expansion through the coupling-out grating, and is finally coupled out of the waveguide substrate.

In particular, the coupling-out grating adopts a switchable grating structure, and the control system correspondingly modulates the switchable grating structure to directionally select and continuously switch the coupling region on the switchable grating structure.

In the present disclosure, by setting a control system in the volume holographic optical waveguide display apparatus to correspondingly modulate the switchable grating structure, the switchable grating structure can be directionally selected and continuously switched by means of electrical control, so as to provide a more rapid, accurate and stable scanning process. In the specific implementation, the grating structure incudes the coupling-in grating and the coupling-out grating, the image pixel point light source is subjected to beam expansion and collimation by the optical mechanical system and is coupled into the waveguide substrate. The beam entering the waveguide substrate is diffracted by the coupling-in grating to produce first-order diffracted waves and is propagated in the waveguide through total internal reflection. The coupling-in grating is set with the highest diffraction efficiency, such that most of the light coupled into the waveguide is diffracted into the first-order diffracted light and is propagated in the waveguide. The diffracted wave is propagated in the waveguide substrate towards the coupling-out grating through total internal reflection, until the diffracted wave reaches to the coupling-out grating, and performs diffraction with the coupling-out grating for the second time. Through diffraction, the beam which is originally propagated in the waveguide through total reflection is diffracted to be propagated towards the surface of the waveguide, is finally coupled out of the waveguide substrate to enter the human eyes for imaging, and the beam produces a pupil expansion effect through the effect of the coupling-out grating, thereby enlarging the exit pupil diameter and the field of view effect of the volume holographic optical waveguide display apparatus.

In addition, the coupling-out grating adopts a switchable grating structure, the coupling region on the coupling-out grating is directionally selected and switched through the control system, thereby reducing the region where a beam is coupled out at a single time, enabling the beam to be emitted from the coupling region at a maximum diffraction efficiency, and improving the diffraction efficiency and brightness of the beam. The coupling-out region on the coupling-out grating is continuously and rapidly switched through the control system to cover all the coupling-out grating arrays, thereby realizing the exit pupil diameter and the field of view effect designed for the original coupling-out grating array. In such configuration, the volume holographic optical waveguide display apparatus does not need to introduce redundant optical elements, and will not introduce additional stray light, thereby possessing both favorable static properties and good dynamic properties.

The grating structure may further include a fold grating, where the collimated light beam is coupled into the waveguide substrate through the coupling-in grating, propagated towards the fold grating, then is subjected to pupil expansion for the first time by the fold grating, further propagated towards the coupling-out grating, subjected to pupil expansion for the second time by the coupling-out grating, and is finally coupled out of the waveguide substrate. Preferably, the fold grating adopts the switchable grating structure.

In one embodiment of the present disclosure, the grating structure in the waveguide system includes a coupling-in grating, a fold grating and a coupling-out grating. The image pixel point light beam is subjected to beam expansion and collimation by the optical mechanical system, and is coupled into the waveguide substrate, the beam entering the waveguide substrate is diffracted by the coupling-in grating to process first-order diffracted waves and is propagated in the waveguide substrate through total internal reflection. The coupling-in grating is set with the highest diffraction efficiency, such that most of the light coupled into the waveguide is diffracted into the first-order diffracted light and is propagated in the waveguide. The diffracted wave is propagated in the waveguide towards the fold grating through total internal reflection, until the diffracted wave reaches to the fold grating, and performs diffraction with the fold grating for the second time, such that the beam turns towards a certain angle. With the effect of the fold grating, the incident beam performs pupil expansion for the first time in the original propagation direction. The beam after secondary diffraction is propagated continuously in a waveguide plane through total internal reflection towards the coupling-out grating, until the beam reaches the coupling-out grating and performs diffraction with the coupling-out grating for the third time, and through the diffraction, the beam which is originally propagated in the waveguide through total reflection is diffracted to be propagated towards the waveguide surface, is finally coupled out of the waveguide substrate, and enters human eyes for imaging. The beam is subjected to pupil expansion for the second time under the effect of the coupling-out grating, and the exit pupil diameter and field of view of the volume holographic optical waveguide display apparatus are enlarged through the two-dimensional pupil expansion solution.

In addition, the coupling-out grating is a switchable grating structure, and the control system is utilized to control and switch the coupling region on the coupling grating and realize rapid scanning, thereby improving the overall brightness and uniformity of the beam emitted from the coupling-out grating, and improving the image quality and market effect. Preferably, the fold grating can also be set as a switchable grating structure, and the fold grating and the coupling-out grating are controlled and scanned by the control system, so as to achieve a two-dimensional scanning mode in the waveguide system, thereby not only achieving the exit pupil diameter originally designed for the grating structure, but also improving the diffraction efficiency and brightness of the beam when the beam is propagated in the waveguide plane, and improving the uniformity and the field of view effect of the emitted light.

In particular, the switchable grating structure may be a grating array formed by a plurality of sub-gratings arranged directionally, and the switchable grating structure is a switchable Bragg grating consisting of holographic polymer dispersed liquid crystals.

In the present disclosure, the switchable grating structure is set to be a grating array formed by a plurality of sub-gratings arranged directionally, such that the adjusting dimension of the switchable grating structure is minimized to a single sub-grating. When the switchable grating structure adopts a switchable Bragg grating consisting of holographic polymer dispersed liquid crystals, where the holographic polymer dispersed liquid crystals are gratings consisting of polymer-rich phases periodically arranged with liquid crystal-rich phases formed by polymerisation-induced phase separation under coherent laser, the grating structure of the required parameters can be formed conveniently and economically by changing the spatial energy distribution of the exposure optical field of the holographic polymer dispersed liquid crystals, thereby conveniently modulating the diffraction efficiency of the switchable grating structure. Additionally, since the liquid crystal material molecules themselves have the property of deviating the direction of the optical axis under the effect of an electric field, the liquid crystal material molecules can change the directions thereof under the effect of an electric field and change the refractive index of the liquid crystals, therefore, this property can be used to modulate the refractive index modulation degree of the grating of the holographic polymer dispersed liquid crystal material or can be used to open or close the grating, and this is also known as a switchable Bragg grating (SBG).

In the present disclosure, the switchable grating structure is a switchable Bragg grating consisting of holographic polymer dispersed liquid crystal materials, and an optical axis of the switchable grating structure is deviated through an applied electric field, so as to conveniently and rapidly define and realize the opening and closing of the grating structure. Moreover, when the switchable grating structure is a switchable Bragg grating consisting of holographic polymer dispersed liquid crystals, since each part of the sub-grating is configured with the highest diffraction efficiency, all of the gratings have the same optical properties, and the gratings can be prepared in batches using the same making process, thereby greatly reducing the complexity and difficulty in making the gratings, meanwhile more conveniently ensuring consistency of all the properties of the grating structure, improving the production efficiency, and further improving the usage performance of the grating structure.

Further, the control system may include a plurality of control electrodes, each of the control electrodes individually modulates one of the sub-gratings and is arranged correspondingly in parallel with the sub-grating, and the coverage region of the control electrode is not smaller than a region of the grating array.

In the present disclosure, the sub-grating is a switchable Bragg grating, such that an electric field of a certain size can be applied to both sides of the sub-grating by the control electrodes to modulate the optical state of the sub-grating. Further, through corresponding connection between the sub-grating and the control electrode and through individual modulation, the coupling region may be accurately and conveniently selected based on the dimension of a single sub-grating, and the diffraction efficiency of each sub-grating is individually modulated. Therefore, the control electrode forms an electrode array correspondingly parallel with the modulated grating array, and the area of the electrode array should be greater than or equal to the area of the grating region that needs to be modulated, such that the grating array is stably modulated. In addition, the size of the sub-grating along the arrangement direction of the grating array is set not greater than the size of a pupil, such that the area of the grating selected to be opened by the control system at a single time is equal to or slightly greater than the size of the pupil; and meanwhile, other gratings are kept in a closed state, therefore, during practical operating process, the beams coupled out at a single time are more concentrated with a high diffraction efficiency, thereby improving the brightness and uniformity of the light emitted at a single time.

Optionally, the control electrodes may be arranged in pairs above the outer plane of the waveguide substrate and correspond in parallel with the sub-gratings modulated by the control electrodes. Alternatively or additionally, the control electrodes may also be arranged in pairs in the waveguide substrate and correspond in parallel with the sub-gratings modulated by the control electrodes. The control electrodes are preferably transparent electrodes.

In the present disclosure, the control electrodes are arranged in pairs and in parallel on both sides of the pupil of the sub-grating to be modulated, so as to construct an electric field in the sub-grating and accurately control the direction of the pupil of the sub-grating, thereby achieving opening or closing of the sub-grating. Preferably, the setting position of the control electrode overlaps with the position where the beam passes through near the sub-grating, and through such a setting, the control electrode is a transparent electrode with a high transmittance rate, which facilitates the coupling in or coupling out of the beam. Further preferably, the control electrode is made of ITO conductive glass to improve the transparency of the coupling-out region.

Optionally, in order to improve the diffraction efficiency of the grating structure and to improve the field angle, the switchable grating structure may be a one-dimensional grating array or a two-dimensional grating array consisting of sub-gratings.

Optionally, in order to improve the uniformity and angle uniformity of local gratings, the switchable grating structure may adopt a multiplexed grating or an overlapped grating as a sub-grating or may adopt a smaller grating array.

Compared with the prior art, the present disclosure has the following beneficial effects.

In the method for improving the display uniformity of a volume holographic optical waveguide according to the present disclosure, by adopting the switchable grating structure, a light beam can only be coupled out for emission from a partial region directionally selected thereon, such that the beams are concentrated on the partial region on the switchable grating structure when light is emitted at a single time, thereby further reducing imbalance of the energy of the beam on the coupling-out region when light is emitted at a single time, and improving the brightness and uniformity of the light emitted at a single time. In addition, the coupling region on the switchable grating structure can be freely selected and continuously switched, such that the light source moves freely in different regions on the switchable grating structure through an output field of view of the switchable grating structure. Since the brightness and angle uniformity of the beam penetrating through each coupling region on the switchable grating structure are all consistent, more balanced optical field distribution is constructed in the full output field of view, thereby improving the overall display effect.

Moreover, during the light emitting at a single time, the light beam is coupled out at the maximum diffraction efficiency thereof when passing through the coupling region, such that the light beam can couple out most of the light energy in one diffraction when passing through the coupling region, thereby further improving brightness and uniformity of light emitted at a single time. By rapidly switching the coupling region, the utilization rate of the beam is ensured to the maximum degree in all the regions, and the overall brightness of the beam is improved.

Tanking a process in which the continuously switched coupling region cover all the regions of the switchable grating structure as one scanning, during one scanning, the light source bearing images is coupled out of all the regions of the switchable grating structure. In addition, the time of one scanning is not more than the visual retention time of human eyes, i.e., the images observed by human eyes through the volume holographic optical waveguide display apparatus are all the images with improved brightness and uniformity, which improves the quality of images observed by human eyes while ensuring the visual experience.

In the volume holographic optical waveguide display apparatus with the high brightness and high uniformity according to the present disclosure, by additionally setting the control system, and adjusting the coupling-out grating or the fold grating in the waveguide system to be the switchable grating structure, the coupling region on the coupling-out grating or the fold grating can be continuously and rapidly switched through the control system to cover the switchable grating structure, thereby not only realizing the one-dimensional or two-dimensional pupil expansion solution designed for the original grating structure and reserving the exit pupil diameter and the field of view effect, but also improving overall brightness and uniformity of emitted light source through one-dimensional scanning or two-dimensional scanning light emission and improving the light effect and the display effect. Furthermore, the volume holographic optical waveguide display apparatus does not need to introduce redundant optical elements, and will not introduce additional stray light, thereby possessing both favorable static properties and good dynamic properties.

### BRIEF DESCRIPTION OF DRAWINGS

FIG. 1 is a schematic cross-sectional view of a switchable Bragg grating composed of holographic polymer dispersed liquid crystals;

FIG. 2 is a schematic view of a waveguide system in which a coupling-out grating is in a one-dimensional grating array;

FIG. 3 is a schematic view of a waveguide system in which a coupling-out grating is in a two-dimensional grating array;

FIG. 4 is a schematic cross-sectional view of a waveguide system in which control electrodes are arranged on both sides of the surface of a waveguide substrate;

FIG. 5 is a schematic cross-sectional view of a waveguide system in which control electrodes are arranged inside a waveguide substrate and on both sides of a grating structure;

FIG. 6 is a schematic view of a waveguide system in which a coupling-out grating array is a multiplexed grating;

FIG. 7 is a schematic plan view of a waveguide system in which a coupling-out grating array is an overlapping grating; and

FIG. 8 is a schematic view of a two-dimensional pupil expansion waveguide system.

### DETAILED DESCRIPTION

It should be noted that the following detailed descriptions are all illustrative and are intended to further illustrate the present disclosure. Unless otherwise indicated, all the technical and scientific terms used herein have the same meaning as is commonly understood by those skilled in the art to which the present disclosure belongs.

It should be noted that the terms used herein are merely intended to describe specific embodiments and are not intended to limit the exemplary embodiments according to the present disclosure. As used herein, unless the context clearly indicates otherwise, the singular forms are intended to include the plural forms as well, and it should also be understood that when the terms “comprising” and/or “including” are used in the present specification, they indicate the presence of features, steps, operations, devices, components, and/or combinations thereof.

The present disclosure is further described in conjunction with specific examples, and the following embodiments are merely for the purpose of explaining the present disclosure, but do not constitute a limitation of the present disclosure. The test samples and test procedures used in the following embodiments include the following contents (if the specific conditions of the experiment are not indicated in the embodiments, they are usually according to conventional conditions, or according to the conditions recommended by the reagent company; the reagents, consumables and the like used in the following embodiments are commercially available if not otherwise indicated).

A method for improving display uniformity of a volume holographic optical waveguide is provided according to an embodiment of the present disclosure. The volume holographic optical waveguide includes a switchable grating structure, and a partial region of the switchable grating structure can be directionally selected as a coupling region, such that the light beams emitted from the light source can only be coupled out of the coupling region at its maximum diffraction efficiency. With the switchable grating structure, the light beams from the light source can only be coupled out for emission from a partial region directionally selected at a single time, such that the beams are concentrated on the partial region of the switchable grating structure during light emitting at a single time, thereby reducing the imbalance of the beam energy on the coupling-out region during light emitting at a single time, and thus improving brightness and uniformity of light emitted at a single time. Moreover, during light emitting at a single time, the light beams from the light source are coupled out at the maximum diffraction efficiency thereof when passing through the coupling region, such that the light beams can couple out most light energy during a single diffraction when passing through the coupling region, thereby further improving the brightness and uniformity of light emission at a single time.

In addition, with free selection and continuous switching of the coupling region on the switchable grating structure, the light beams from the light source move freely in different regions on the switchable grating structure through the output field of view of the switchable grating structure, and all the fields of view of the switchable grating structure is restored. Furthermore, since the brightness and angle uniformity of the beam that passes through each coupling region on the switchable grating structure are both consistent, the utilization rate of beams is guaranteed to the maximum extent in all regions, and the overall brightness of the beams is improved, thereby constructing more balanced optical field distribution in the full output field of view and thus improving the overall display effect. Taking a process in which the continuously switched coupling region covers all the regions of the switchable grating structure as one scanning, during one scanning, the light beams bearing images are coupled out once from all the regions of the switchable grating structure, and the time for one scanning is not more than the visual retention time of human eyes, which ensures the visual experience and improves the quality of images observed by the human eyes at the same time. Preferably, the light beam with images can repeatedly scan on the same switchable grating structure, so as to significantly improve the visual communication effect.

In particular, the switchable grating structure is designed into a grating array formed by a plurality of sub-gratings arranged directionally, and by controlling the opening of part of the sub-gratings in the grating array and controlling the closing of the other part of sub-gratings, the coupling region on the switchable grating structure can be directionally selected conveniently and rapidly. In such way, selection of the coupling region can be controlled by the sub-grating dimension, which improves precision and convenience of selection and control of the coupling region. Preferably, by controlling and selecting the sub-gratings and switching the coupling regions, the manner for scanning the switchable grating structure is further broadened, so as to adapt to different disclosure scenarios and bring different visual effect experiences. Specifically, sequential scanning or random scanning may be used, and at least one sub-grating is opened each time during the sequential scanning or random scanning process.

Preferably, the size of the sub-gratings in the arrangement direction of the grating array is not greater than the size of a pupil. With such configuration, the area of the grating selected to be opened at a single time by the control system is equal to or slightly greater than the size of the pupil. In practical operating process, the beams coupled at a single time are more concentrated with high diffraction efficiency, thereby improving brightness and uniformity of light emitted at a single time. In particular, the control system includes a plurality of control electrodes, each control electrode individually modulates one sub-grating correspondingly, thereby accurately and conveniently selecting the coupling region based on a single sub-grating dimension and individually modulating the diffraction efficiency of each sub-grating. Furthermore, the coverage region of the control electrode is not smaller than the region of the grating array, which achieves stable modulation of the grating array.

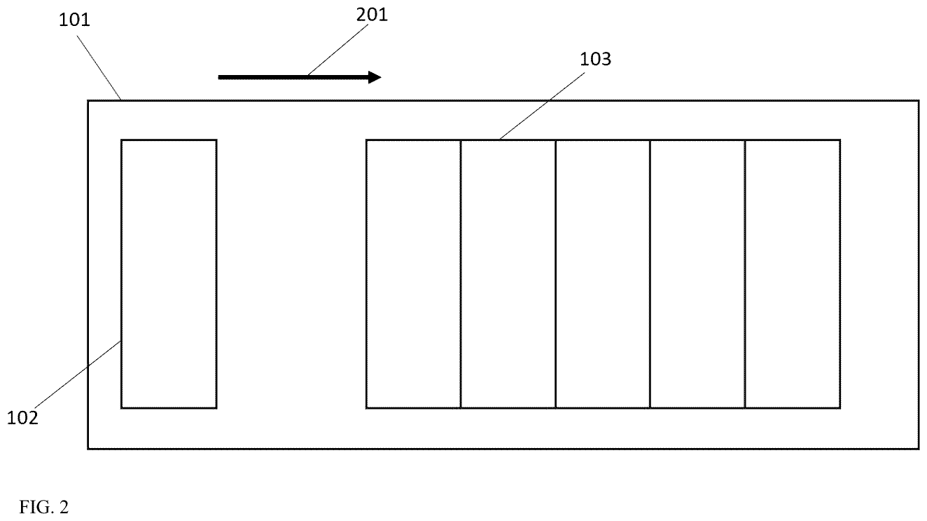

A volume holographic optical waveguide display apparatus is provided according to an embodiment of the present embodiment, including an optical mechanical system, a waveguide system and a control system. The optical mechanical system is configured to emit a collimated light beam into the waveguide system. The waveguide system includes a waveguide substrate and a grating structure arranged in the waveguide substrate. The grating structure is configured to guide the collimated light beams into the waveguide substrate for propagation, modulate the collimated light beams, and couple the light beams modulated out of the waveguide system. In particular, as shown in FIG. 2, the waveguide substrate 101 consisting of a single layer or a plurality of layers of transparent glass constructs a space for modulation of the light beams. The grating structure at least includes a coupling-in grating 102 and a coupling-out grating 103. The collimated light beam is coupled into the waveguide substrate 101 through the coupling-in grating 102 and is propagated in the waveguide substrate 101 along the propagation direction 201. The coupling-out grating 103 is a switchable grating structure. The control system is configured to directionally select and continuously switch the coupling region on the coupling-out grating.

The image pixel point light source is subjected to beam expansion and collimation by the optical mechanical system and is coupled into the waveguide substrate. The beam entering the waveguide substrate is diffracted by the coupling-in grating to produce first-order diffracted waves which are propagated in the waveguide through total internal reflection. The coupling-in grating is set with the highest diffraction efficiency, such that most of the light coupled into the waveguide is diffracted into the first-order diffracted light which is propagated in the waveguide. The diffracted wave is propagated in the waveguide towards the coupling-out grating through total internal reflection, until that the diffracted wave reaches to the coupling-out grating, and performs diffraction with the coupling-out grating for the second time. Through the diffraction, the beam which is originally propagated in the waveguide through total reflection is subjected to pupil expansion and is finally coupled out of the waveguide substrate to enter the human eyes for imaging. Additionally, the coupling region can be continuously and rapidly switched through the control system to cover all the regions of the coupling-out grating, the emitted light is superimposed through scanning. Therefore, the final light effect restores the exit pupil diameter and field of view effect designed for the original coupling-out grating array.

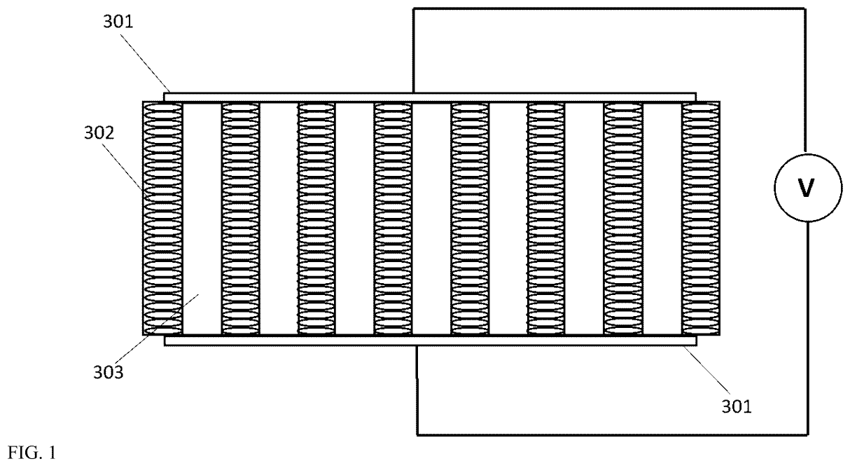

In addition, the coupling-out grating is a switchable Bragg grating consisting of holographic polymer dispersed liquid crystals. Since the holographic polymer dispersed liquid crystals are gratings consisting of polymer-rich phases periodically arranged with liquid crystal-rich phases formed by polymerisation-induced phase separation under coherent laser, the grating structure of the required parameters is conveniently and economically formed by changing the spatial energy distribution of the exposure optical field of the holographic polymer dispersed liquid crystals. Furthermore, as the liquid crystals themselves have the property of deviating the direction of the optical axis under the effect of an electric field, as shown in FIG. 1, the optical axis direction of the liquid crystal material molecules 302 can be changed along with the pressure state applied by the control electrodes 301 in pairs, when no pressure is applied, the optical axis of the liquid crystal material molecules 302 vertically points to the polymer material 303, at this time, the liquid crystal material molecules 302 have the maximum refractive index in the horizontal direction. After the control electrode 301 applies a certain voltage, the optical axis of the liquid crystal material molecules 302 turns to be parallel with the polymer material 303, at this time, the refractive index of the liquid crystal material molecule 302 in the horizontal direction is the lowest and is close to the refractive index of the polymer material 303. In addition, the difference between the refractive indices of the liquid crystal material molecule 302 and the polymer material 303 can be adjusted by the magnitude of the applied voltage, thereby adjusting the diffraction efficiency of the grating. As to the switchable Bragg grating consisting of holographic polymer dispersed liquid crystals, an electric field can be applied to both sides of the pupil to deflect the pupil and further modulate the transmittance rate of the beam with respect to the grating, thereby achieving opening or closing of the grating, and directionally selecting the coupling-out region of the beam.

Therefore, the control system may include a plurality of control electrodes 301, the opening and closing of the sub-gratings in the coupling-out grating array are switched through the control electrode, thus directionally selecting the coupling regions on the coupling-out grating array, reducing the region of a single coupling out of a beam, and improving the diffraction efficiency and brightness of the beam. The control electrode 301 is correspondingly connected with the sub-grating and individually modulates the sub-grating, and each sub-grating may be physically divided, or may not be physically divided and may be defined by a region of the control electrode 301, and the sub-gratings may all be individually modulated with any diffraction efficiency between a maximum diffraction efficiency and a diffraction efficiency of zero.

As the sub-gratings in the grating structure are arranged correspondingly in parallel with the control electrodes 301 and are individually modulated by the control electrodes 301, each control electrode 301 can be individually connected to the control system, and particularly, the control electrode 301 can be a voltage controller, and individually modulates the diffraction efficiency of each sub-grating. Therefore, the control electrodes 301 form an electrode array corresponding to the grating array that is modulated by the control electrode 301, and the area of the electrode array should be greater than or equal to the area of the grating region that needs to be modulated, so as to stably modulate the grating array. Specifically, in order to facilitate corresponding modulation between the control electrodes 301 and the sub-gratings, and to maximize the electrical control function while also avoiding interference with the function of the waveguide system, the control electrodes 301 should be arranged on the waveguide substrate 101 in pairs and should be arranged correspondingly in parallel with the sub-gratings modulated by the control electrode 301.

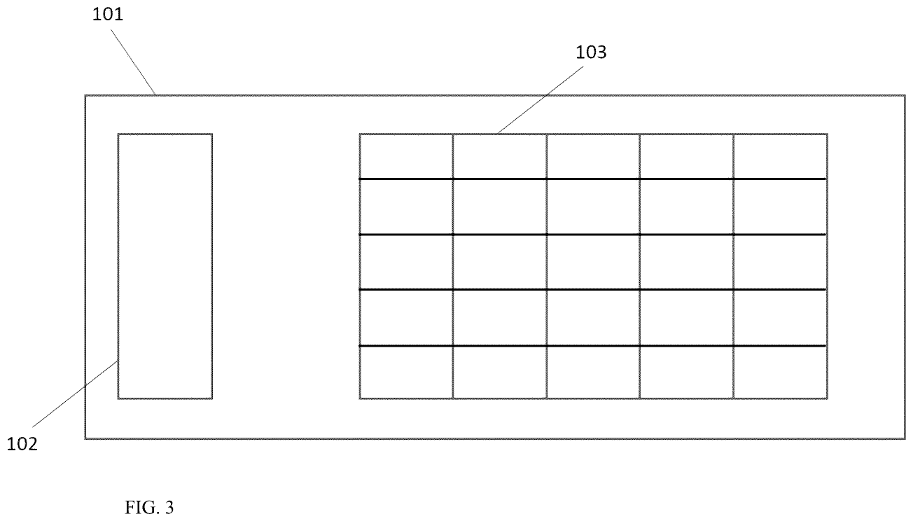

Alternatively or additionally, in order to improve the diffraction efficiency of the grating structure and to improve the field angle, the coupling-out grating may be a one-dimensional grating array consisting of a plurality of sub-gratings, as shown in FIG. 2, or a two-dimensional grating array, as shown in FIG. 3.

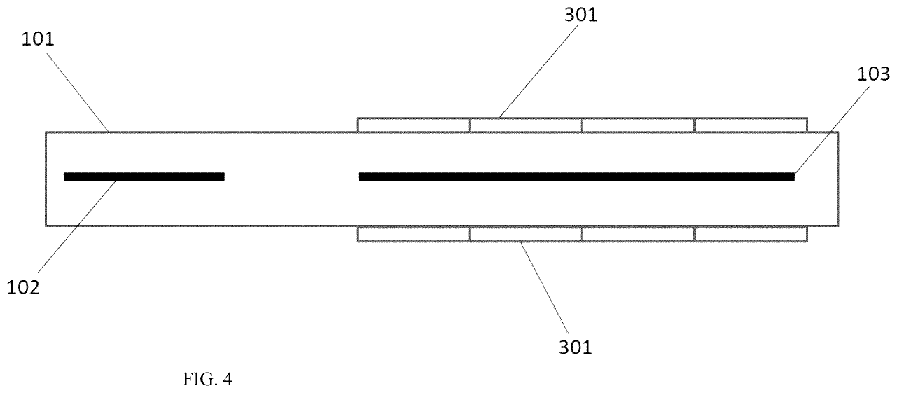

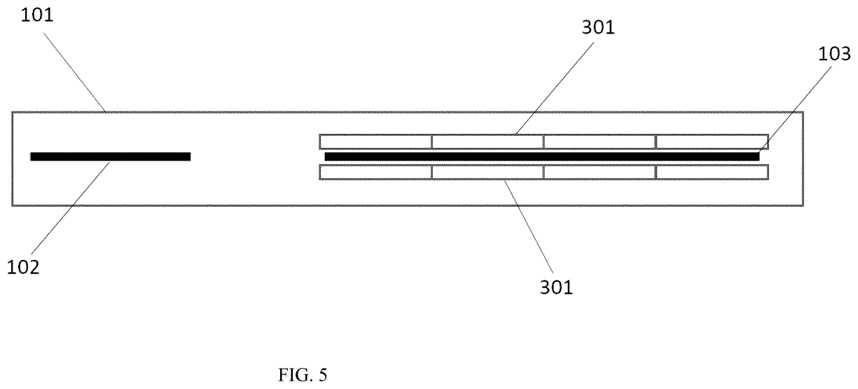

Alternatively or additionally, in order to facilitate corresponding modulation between the control electrodes 301 and the sub-gratings, and to maximize the electrical control function while also avoiding interference with the function of the waveguide system, as shown in FIG. 4, the control electrodes 301 are arranged on the surfaces of both sides of the waveguide region corresponding to the coupling-out grating 103, and the control electrodes 301 are arranged in pairs and arranged correspondingly in parallel with the grating structures modulated by the control electrode 301. Alternatively, as shown in FIG. 5, the control electrodes 301 are arranged inside the waveguide substrate 101 and are arranged on both sides of the coupling-out grating 103. The control electrodes 301 may or may not contact with the modulated grating structure. Preferably, the control electrode 301 is a transparent electrode which is made of ITO transparent conductive glass.

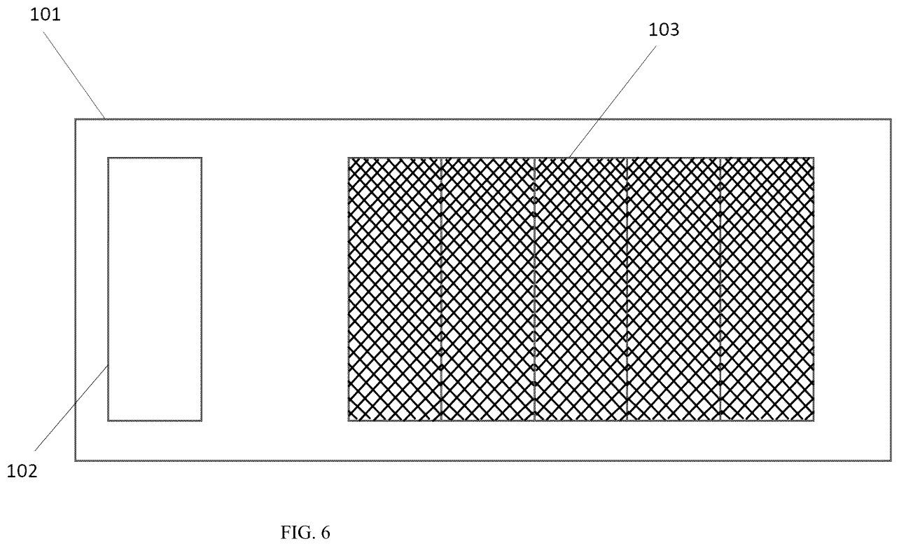

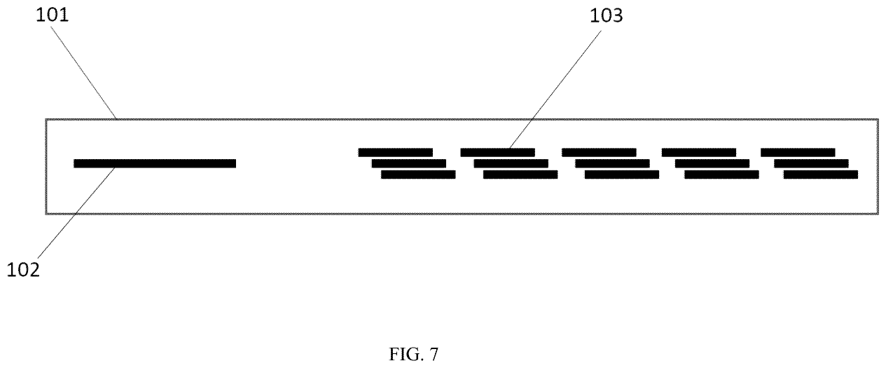

Alternatively or additionally, in order to improve the uniformity and angle uniformity of local gratings, as shown in FIG. 6 and FIG. 7, multiplexed gratings, overlapped gratings, or smaller grating arrays may be adopted.

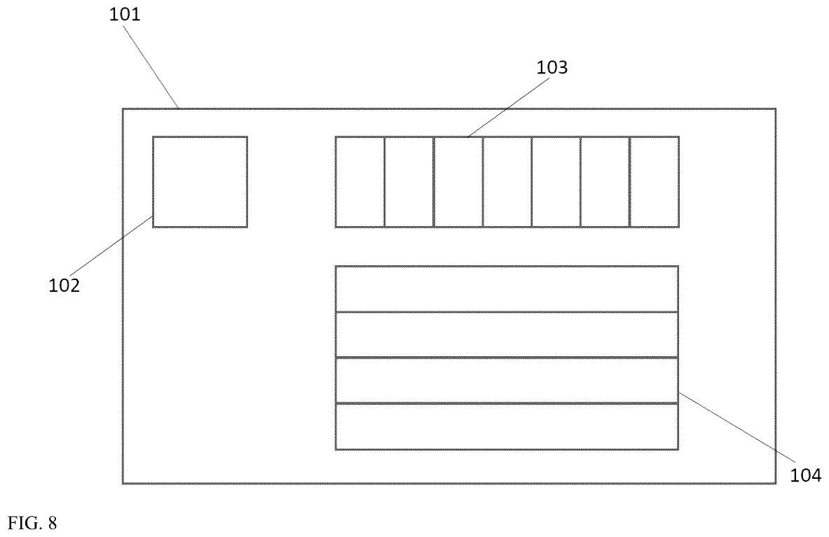

The grating structure of the volume holographic optical waveguide display apparatus in the present embodiment may further include a fold grating 104. A depicted in FIG. 8, the grating structure includes a coupling-in grating 102, a fold grating 104, and a coupling-out grating 103. Preferably, in the waveguide system, the fold grating 104 and the coupling-out grating 103 both have an array structure, and the fold grating 104 and the coupling-out grating 103 are both in switchable grating structure, which provides a two-dimensional pupil expansion waveguide system. The fold grating 104 and the coupling-out grating 103 may be one-dimensional arrays or two-dimensional arrays, the fold grating 104 and the coupling-out grating 103 may also be provided with configurations of various grating structures and configurations of the control system mentioned above, such that the fold grating 104 and the coupling-out grating 103 may be directionally selected and continuously switched by the control system, so as to jointly constitute a two-dimensional scanning mode to reflect the dynamic property of the waveguide display.

Apparently, the above embodiments of the present disclosure are merely examples for merely clearly illustrating the technical solutions of the present disclosure, and are not intended to limit the specific embodiments of the present disclosure. Any modifications, equivalent substitutions and improvements made within the spirit and principles of the claims of the present disclosure shall all fall within the protection scope of the claims of the present disclosure.

1. A method for improving display uniformity of a volume holographic optical waveguide, comprising:
providing the volume holographic optical waveguide with a switchable grating structure, wherein a partial region of the switchable grating structure is directionally selected as a coupling region thereof, in a way that a light beam from a light source is only capable of being coupled out of the coupling region at the maximum diffraction efficiency thereof; and
continuously switching the coupling region on the switchable grating structure, wherein a process in which the continuously switched coupling region covers all the regions of the switchable grating structure is taken as one scanning, and the time for one scanning is not more than a visual retention time of human eyes.

2. The method according to claim 1, wherein the switchable grating structure is a grating array formed by a plurality of sub-gratings arranged directionally, and the coupling region of the grating array is directionally selected by controlling opening or closing of part of the sub-gratings in the grating array; and
wherein the scanning manner is sequential scanning or random scanning, and at least one of the sub-gratings is opened each time during sequential scanning or random scanning.

3. A volume holographic optical waveguide display apparatus, which is configured to conduct the method according to claim 1 to improve display uniformity thereof, the apparatus comprises:
an optical mechanical system, configured to emit a collimated light beam;
a waveguide system, comprising a waveguide substrate and a grating structure arranged in the waveguide substrate, the grating structure at least comprising a coupling-in grating and a coupling-out grating, wherein the collimated light beam is coupled into the waveguide substrate through the coupling-in grating, propagated towards the coupling-out grating, and then subjected to pupil expansion by the coupling-out grating and coupled out of the waveguide substrate; and
a control system,
wherein the coupling-out grating is a switchable grating structure; and the control system is configured to modulate the switchable grating structure to directionally select and continuously switch a coupling region on the switchable grating structure.

4. The apparatus according to claim 3, wherein the grating structure further comprises a fold grating, wherein the collimated light beam is coupled into the waveguide substrate through the coupling-in grating, propagated towards the fold grating, then subjected to pupil expansion for a first time by the fold grating, further propagated towards the coupling-out grating, and subjected to pupil expansion for a second time by the coupling-out pupil and finally coupled out of the waveguide substrate.

5. The apparatus according to claim 4, wherein the fold grating is a switchable grating structure.

6. The apparatus according to claim 3, wherein the switchable grating structure is a grating array formed by a plurality of sub-gratings arranged directionally, and the switchable grating structure is a switchable Bragg grating consisting of holographic polymer dispersed liquid crystals.

7. The apparatus according to claim 6, wherein the control system comprises a plurality of control electrodes, each of the plurality of control electrodes is individually configured to modulate one of the sub-gratings and arranged correspondingly in parallel with the respective sub-grating, and a coverage region of the plurality of control electrodes is not smaller than a region of the grating array.

8. The apparatus according to claim 7, wherein the plurality of control electrodes are arranged in pairs above an outer plane of the waveguide substrate and correspondingly in parallel with the plurality of sub-gratings modulated by the respective control electrodes.

9. The apparatus according to claim 7, wherein the plurality of control electrodes are arranged in pairs in the waveguide substrate and correspondingly in parallel with the plurality of sub-gratings modulated by the respective control electrodes.

10. The apparatus according to claim 7, wherein the control electrodes are transparent electrodes.

11. The apparatus according to claim 7, wherein the grating array is a one-dimensional array or a two-dimensional array.

12. The apparatus according to claim 7, wherein the plurality of sub-gratings are one or more of overlapped gratings or multiplexed gratings.
